(19) United States
(12) Patent Application Publication
(10) Pub. No.: US 2005/0069435 A1
(43) Pub. Date: Mar. 31, 2005

(54) Fuel pump

(75) Inventors: Masaki Ikeya, Obu-shi (JP); Yoji Hashimoto, Tokai-shi (JP)

Correspondence Address: Ira J. Schultz;DENNISON, SCHULTZ, DOUGHERTY & MACDONALD, Suite 105, 1727 King Street, Alexandria, VA, 22314-2700, US

(73) Assignee: Aisan Kogyo Kabushiki Kaisha & Aichi Steel Corporation

(21) Appl. No.: 10/950,586

(22) Filed: Sep. 28, 2004

(30) Foreign Application Priority Data
Sep. 29, 2003 (JP) 2003-338504

(51) Int. Cl. H02K 21/12; F04B 17/00

(52) U.S. Cl. 417/423.14; 417/423.1; 417/423.3; 417/423.7

(57) ABSTRACT

A fuel pump with improved pumping performance having a high motor torque and a sufficient cross sectional area of fuel passage is provided.

The motor section (2) of the fuel pump has a columnar rotor (21) having a shaft (7) for rotating the pump section (1), and a ring magnet (5, 35, 45, 55, 65, 75, 85) surrounding an outer circumference face of the rotor (21). There is provided a minute clearance between the rotor (21) and the magnet (5, 35, 45, 55, 65, 75, 85). The motor section (2) further has a cylindrical yoke (4, 34, 46, 56, 66) surrounding and contacting an outer circumference face of the magnet (5, 35, 45, 55, 65, 75, 85). A fuel passage (27, 37, 47, 57,67, 77, 87, 97, 127) having a sufficient cross sectional area is formed at a location removed from a magnetic path along which a substantial portion of magnetic flux (F) flows between the rotor (21), the magnet (5, 35, 45, 55, 65, 75, 85), and the yoke (4, 34, 46, 56, 66).

### CROSS REFERENCE TO RELATED APPLICATION

This application claims priority under the Paris convention to Japanese Patent Application number 2003-338504, which was filed on Sep. 29, 2003, and entire content of which are hereby incorporated by reference.

### BACKGROUND OF THE INVENTION

1. Field of the Invention

The present invention relates to a fuel pump for drawing in fuel such as gasoline etc., increasing the pressure thereof, and discharging the pressurized fuel.

2. Description of Related Art

A fuel pump comprises a pump section and a motor section for rotating the pump section, these being provided within a housing. The motor section comprises an armature and a magnet. The armature has a shaft supported in a manner allowing rotation, a rotor fixed to the shaft, and a commutator. The rotor comprises a core having laminated iron plates, and coils wound around the core. Ends of each coil are connected with the commutator. An end of the shaft fits with the pump section, and thus rotates the pump section.

FIG. 25 shows a cross-sectional view of the pump section. A rotor 121 is fixed to a shaft 107. A pair of semicircular arc-shaped magnets 105 is located so as be adjacent to an outer circumference face of the rotor 121. A pair of holders 123 is inserted between end faces of the pair of magnets 105. This fixes the pair of magnets 105 in a state whereby they make contact with an inner circumference face of a housing 104.

Highly pressurized fuel that is delivered from the pump section is discharged to the exterior of the fuel pump via a clearance between the rotor 121 and the magnets 105. However, the clearance between the rotor 121 and the magnets 105 is minute, and the quantity of fuel that flows is small. If an insufficient quantity of fuel is flowing, the performance of the fuel pump falls. In addition, the heat generated by the coils of the rotor 121 cannot be cooled.

In the conventional fuel pump, a pair of spaces 125 that are formed between inner walls of the holders 123 and the outer circumference face of the rotor 121, and that extend in the axial direction, is used as fuel passages. Using these spaces 125 allows a sufficient flow of fuel to be maintained.

### SUMMARY OF THE INVENTION

The smaller the clearance between the rotor 121 and the magnets 105, the greater the magnetic flux passing through the rotor 121, and the higher the motor torque that can be obtained. Further, the greater the area of the mutually facing faces of the rotor 121 and the magnets 105, the greater the magnetic flux passing through the rotor 121, and the higher the motor torque that can be obtained.

In the conventional fuel pump shown in FIG. 25, the pair of magnets 105 are located with their side faces mutually separated. This maintains the fuel passages 125. As a result, the rotor 121 is not enclosed by the magnets 105 at the locations where these fuel passage 125 are formed. Maintaining the fuel passages 125 thus leads to a reduction in the magnetic flux passing through the rotor 121. A sufficiently high motor torque cannot be obtained.

Further, errors in the shape of each of the magnets 105 make it difficult to form a completely circular inner circumference face when the pair of semicircular arc-shaped magnets 105 are joined together to form a ring-shaped magnet. As a result, inner circumference faces of the magnets 105 become separated from the outer circumference face of the rotor 121 in the vicinity of each end face of the magnets 105. This further reduces the magnetic flux passing through the rotor 121.

The present invention aims to present a fuel pump in which a sufficient fuel passage is maintained, and a high motor torque is simultaneously obtained.

A fuel pump of the invention has a pump section and a motor section. The motor section comprises a columnar rotor having a shaft for rotating the pump section, a ring magnet surrounding an outer circumference face of the rotor, there being a minute clearance between the rotor and the magnet, and a cylindrical yoke surrounding and contacting an outer circumference face of the magnet. A fuel passage of the fuel pump of the invention is formed at a location removed from a magnetic path along which a substantial portion of magnetic flux flows between the rotor, the magnet, and the yoke.

The fuel pump of the present invention utilizes a ring magnet. This ring magnet has no gaps in its circumference. It is possible to realize a ring magnet which has no gaps in its circumference by joining two partial arc-shaped magnets whose end faces fit tightly together. However, a ring magnet formed of one piece magnet that is originally ring shaped easily maintains its accuracy of shape, and is preferred.

If a ring magnet with no gaps in its circumference is utilized, the rotor is enclosed by the ring magnet along 360 degrees. Consequently, the magnetic flux passing through the rotor is increased, and a high motor torque can be obtained.

In the fuel pump of the present invention, the fuel passage is formed at a location removed from a magnetic path along which a substantial portion of magnetic flux flows between the rotor, the magnet, and the yoke. Since the fuel passage is formed at a location removed from the magnetic path, the magnetic flux flowing between the rotor, the magnet, and the yoke does not decrease even though the fuel passage is maintained. According to the present invention, a fuel pump can be realized in which a sufficient fuel passage is maintained and a high motor torque is simultaneously obtained.

The magnetic flux flowing between the rotor, the magnet, and the yoke flows along a circulation path (a magnetic path) as follows: the magnetic flux enters the rotor from an N pole at the inner circumference face side of the ring magnet, flows in the circumference direction of the rotor, enters the ring magnet at an S pole at the inner circumference face side of the ring magnet, flows in the radial direction of the ring magnet, enters the yoke from an N pole at the outer circumference face side of the ring magnet, flows in the circumference direction of the yoke, enters the ring magnet at an S pole at the outer circumference face side of the ring magnet, flows in the radial direction of the ring magnet, and enters the rotor from the N pole at the inner circumference face side of the ring magnet.

As a result, a boundary between the poles of the ring magnet, a location within the yoke facing a central part of one of the poles of the ring magnet, or the interior of the rotor is removed from the magnetic path. If the fuel passage is formed in these locations, the magnetic flux flowing between the rotor, the magnet, and the yoke is not decreased.

In the motor section of the fuel pump, there is provided a yoke at an outer side of the magnet. If the housing is made from metal, the housing itself can function as the yoke. The yoke and the housing may of course also be formed separately. In that case, the housing may be molded from resin, etc.

When the ring magnet is to be fitted tightly against an inner wall of the yoke, the ring magnet is usually press fitted into the yoke. The yoke is cylindrical, and its inner wall is a smooth face. The ring magnet must be press fitted into the yoke with great force so that, in its predetermined position at the inner wall of the yoke, the ring magnet fits tightly therewith and cannot rotate or be removed. However, if this press fitting force is great, the ring magnet may be damaged.

In one of the aspects of the present invention, the ring magnet and the yoke are coupled mechanically and the ring magnet is fixed by this means in its predetermined position at the inner wall of the yoke. The ring magnet cannot be removed from the yoke, and is prevented from rotating within the yoke.

### BRIEF DESCRIPTION OF THE DRAWINGS

FIG. 1 is a vertical cross-sectional view of a fuel pump of a first embodiment.

FIG. 2 is a horizontal cross-sectional view of a motor section of the first embodiment.

FIG. 3 is a reference view for explaining the first embodiment.

FIG. 4 is a horizontal cross-sectional view of a motor section of a second embodiment.

FIG. 5 is a horizontal cross-sectional view of a motor section of a third embodiment.

FIG. 6 is a horizontal cross-sectional view of a motor section of a fourth embodiment.

FIG. 7 is a horizontal cross-sectional view of a motor section of a fifth embodiment.

FIG. 8 is a first vertical cross-sectional view of essential parts of the motor section of the fifth embodiment.

FIG. 9 is a second vertical cross-sectional view of essential parts of the motor section of the fifth embodiment.

FIG. 10 is a vertical cross-sectional view of a yoke of the fifth embodiment.

FIG. 11 is a vertical cross-sectional view of a magnet of the fifth embodiment.

FIG. 12 is a vertical cross-sectional view for explaining the assembly process of the motor section of the fifth embodiment.

FIG. 13 is a horizontal cross-sectional view of a motor section of a sixth embodiment.

FIG. 14 is a vertical cross-sectional view of essential parts of the motor section of the sixth embodiment.

FIG. 15 is a horizontal cross-sectional view of a motor section of a seventh embodiment.

FIG. 16 is a vertical cross-sectional view of essential parts of the motor section of the seventh embodiment.

FIG. 17 is a vertical cross-sectional view of essential parts of a motor section of an eighth embodiment.

FIG. 18 is a horizontal cross-sectional view of a rotor of the eighth embodiment.

FIG. 19 is a vertical cross-sectional view of essential parts of a motor section of a ninth embodiment.

FIG. 20 is a horizontal cross-sectional view of a rotor of the ninth embodiment.

FIG. 21 is a vertical cross-sectional view of essential parts of a motor section of a tenth embodiment.

FIG. 22 is a vertical cross-sectional view for explaining the assembly process of the motor section of the tenth embodiment.

FIG. 23 is a vertical cross-sectional view for explaining the assembly process of a motor section of an eleventh embodiment.

FIG. 24 is a vertical cross-sectional view for explaining the assembly process of a motor section of a twelfth embodiment.

FIG. 25 is a horizontal cross-sectional view of a motor section of a conventional fuel pump.

### PREFERRED EMBODIMENTS TO PRACTICE THE INVENTION

(First Embodiment)

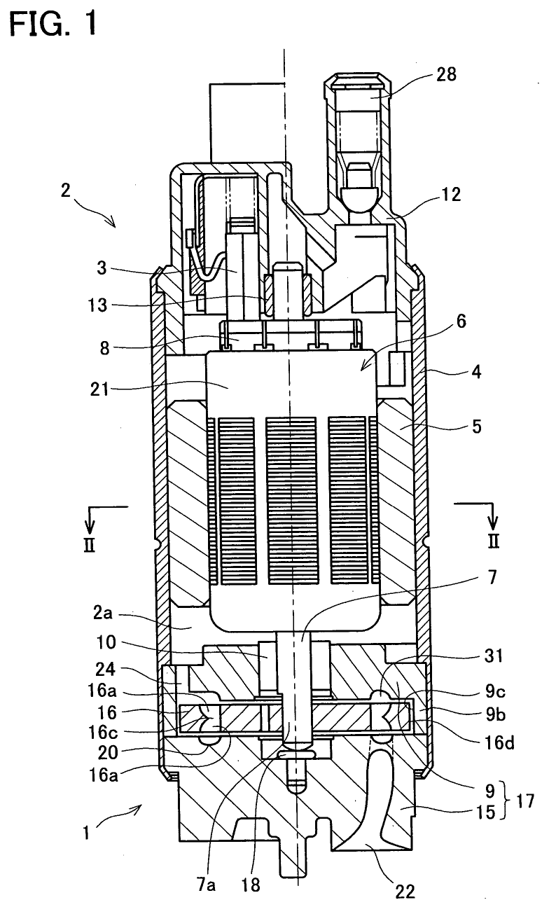

A first embodiment practicing the present invention is described referring to FIGS. 1 to 3.

A fuel pump of the present embodiment is a fuel pump used in a motor vehicle. The fuel pump is utilized within a fuel tank and is utilized for supplying fuel to an engine of the motor vehicle. As shown in FIG. 1, the fuel pump is composed of a pump section 1 and a motor section 2 for driving the pump section 1.

The pump section 1 is composed of a pump cover 9, a pump body 15, an impeller 16, etc. The pump cover 9 and the pump body 15 are formed by, for example, die casting aluminum, and the two are fitted together to form a casing 17 wherein the impeller 16 is housed.

The impeller 16 is formed in substantially a disc shape by means of resin molding. Recesses 16a are formed therein in an area extending. inwards for a determined distance from an outer circumference face 16d of the impeller 16. The recesses 16a that are repeated in the circumference direction form a group of recesses 16a. The group of recesses 16a is formed in both an upper and an lower faces of the impeller 16, and a base portion of each of the upper and lower recesses 16a communicates via a through hole 16c. The outer circumference face 16d of the impeller 16 is a circular face without irregularities.

A fitting shaft member 7a—this being D-shaped in cross-section—at a lower end portion of a shaft 7 fits into a fitting hole that is D-shaped in its cross-section and is formed in the center of the impeller 16. By this means, the impeller 16 is connected with the shaft 7 in a manner allowing follow-up rotation whereby slight movement along the axial direction is allowed.

As shown in FIG. 1, a groove 20 is formed in an upper face of the pump body 15 in an area opposite the recesses 16a in the lower face of the impeller 16. This groove 20 extends continuously along the direction of rotation of the impeller 16 from an upper flow end to a lower flow end. An intake hole 22 is formed in the pump body 15. This intake hole 22 extends from a lower face of the pump body 15 to the upper flow end of the groove 20. The intake hole 22 communicates between the interior and the exterior (the interior of the fuel tank) of the casing 17.

As shown in FIG. 1, a groove 31 is formed in a lower face of the pump cover 9 in an area opposite the recesses 16a in the upper face of the impeller 16. This groove 31 extends continuously along the direction of rotation of the impeller 16 from an upper flow end to a lower flow end. A discharge hole 24 is formed in the pump cover 9. This discharge hole 24 extends from the lower flow end of the groove 31 to an upper face of the pump cover 9. The discharge hole 24 passes from the interior to the exterior (an inner space 2a of the motor section 2) of the casing 17. The pump cover 9 separates the pump section 1 and the motor section 2.

An inner circumference face 9c of a circumference wall 9b of the pump cover 9 faces the impeller outer circumference face 16d along the entire circumference of the pump cover 9. A minute clearance is formed therebetween. In FIG. 1, for the sake of clarity, the clearance is represented as larger than it is in reality.

The pump body 15, this being in a superposed state with the pump cover 9, is fixed by means of caulking or the like to a lower end portion of a housing 4. A thrust bearing 18 is fixed to a central portion of the pump body 15. The thrust load of the shaft 7 is received by the thrust bearing 18.

The groove 31 extending in the circumference direction of the pump cover 9, and the groove 20 extending in the circumference direction of the pump body 15, extend along the direction of rotation of the impeller 16, and extend from the intake hole 22 to the discharge hole 24. When the impeller 16 rotates, the fuel within the fuel tank is drawn into the casing 17 from the intake hole 22. A portion of the fuel taken in from the intake hole 22 flows along the groove 20. The remaining portion of the fuel taken in from the intake hole 22 enters the recesses 16a of the impeller 16, passes through the through holes 16c while a revolving current of this fuel is being caused to occur within the recesses 16a, enters the groove 31, and flows along the groove 31. The pressure of the fuel rises as it flows along the grooves 20 and 31. The fuel that has been pressurized flowing along the groove 20 passes through the through holes 16c of the impeller 16 and flows into the groove 31. The fuel that has been pressurized flowing along the groove 20 merges with the fuel that has been pressurized flowing along the groove 31. After merging, the fuel is delivered from the discharge hole 24 to the motor section 2. The highly pressurized fuel delivered to the motor section 2 is delivered to the exterior of the pump section 2 from a discharge port 28 formed in a motor cover 12. A fuel passage within the motor section 2 will be described in detail later.

The motor section 2 comprises a direct current motor with a brush 3. The motor section 2 comprises the approximately cylindrical metal housing 4, a ring magnet 5 that is made of permanent magnet and is fixed within the housing 4, and an armature 6 that is provided concentrically with the ring magnet 5.

The armature 6 comprises the shaft 7, a rotor 21 fixed to the shaft 7, and a commutator 8 that supplies electric current to the rotor 21. The rotor 21 comprises a core having laminated iron plates which are provided with slots, and coils that are wound, using the slots, around the core. The commutator 8 is connected with ends of the each coil. The brush 3 is located so as to make contact with the commutator 8. The brush 3 pushes the commutator 8 by means of a spring.

A lower portion of the shaft 7 of the armature 6 is supported, via a bearing 10 and in a manner allowing rotation, on the pump cover 9. Furthermore, an upper end of the shaft 7 is supported, via a bearing 13 and in a manner allowing rotation, on the motor cover 12. The discharge port 28 is formed in the motor cover 12. The motor cover 12 is fixed to the housing 4.

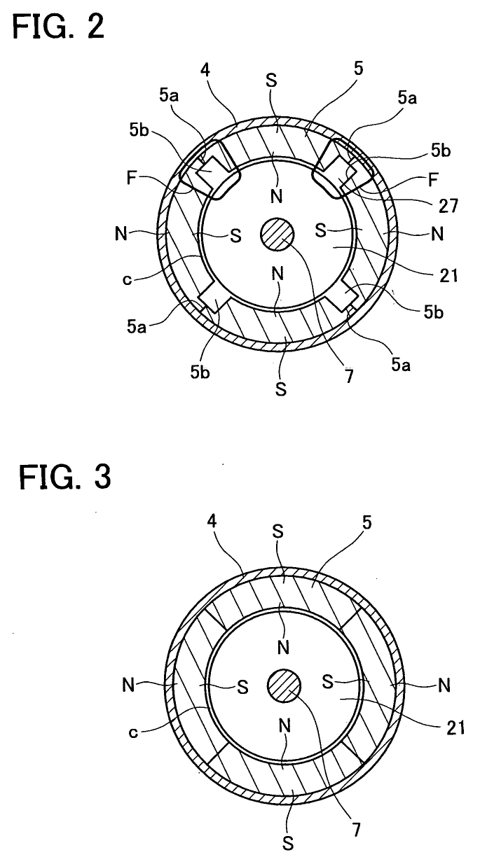

FIG. 2 shows a cross-sectional view along the line II-II of FIG. 1. As shown in FIG. 2, the ring magnet 5 is provided with four poles. The poles at the inner circumference face, and the poles at the outer circumference face opposing these, are opposite poles. In FIG. 2, beginning at the 12 o'clock position and proceeding in a clockwise direction, the poles at the inner circumference face have the sequence: N, S, N, S. The poles at the outer circumference face have the sequence: S, N, S, N. Adjoining poles are separated by 90 degrees. Grooves 5b that extend in the axial direction are formed at locations where boundary lines 5a between the poles of the magnet 5 are exposed at the inner circumference face.

The housing 4 makes contact with the outer circumference face of the ring magnet 5 and encloses the ring magnet 5. The housing 4 is formed from metal that has low magnetic resistance, and serves a dual function as a yoke.

Power is transmitted from the brush 3 to the coils of the rotor 21 via the commutator 8. Thereupon, magnetomotive force is generated in the coils, and magnetic flux is generated that circulates along the rotor 21, the magnet 5, and the yoke 4. Since the clearance formed between the outer circumference face of the rotor 21 and the inner circumference face of the magnet 5 is small, there is little magnetic resistance. The distance between the rotor 21 and the magnet 5 grows greater at locations where grooves 5b are present. However, as shown in FIG. 2, a substantial portion of the magnetic flux F flows along a magnetic path circulating the S pole at the inner circumference face side of the magnet 5, the rotor 21, the N pole at the inner circumference face side of the magnet 5, the S pole at the outer circumference face side of the magnet 5, the yoke 4, and the N pole at the outer circumference face side of the magnet 5. The boundary lines 5a between the poles of the magnet 5 are removed or distant from the magnetic path. As a result, the presence of the grooves 5b hardly weakens the magnetic flux passing through the rotor 21. In the present embodiment, the grooves 5b are formed in locations removed from the magnetic path along which a substantial portion of the magnetic flux F flows between the rotor 21, the magnet 5, and the yoke 4. Consequently, the grooves 5b hardly exert a weakening influence on the magnetic flux passing through the rotor 21. The present embodiment allows a large motor torque to be maintained.

The ring magnet 5 is physically integral even at the boundary lines 5a between the poles of the magnet 5. This ring magnet is not assembled to form a ring shape, but is instead formed from material that was originally ring shaped. As a result, the ring magnet 5 easily maintains its accuracy of shape, and the inner circumference face and outer circumference face approach a complete circle. The clearance between the rotor 21 and the magnet 5 can be made extremely small. Further, the magnet 5 and the yoke (housing) 4 can be fitted extremely closely together. This is also effective in increasing the magnetic flux passing through the rotor 21, and a large motor torque can be realized.

In the configuration described above, when voltage is applied to the brush 3 that has been connected with an external power source, current flows, via the commutator 8, from the brush 3 through coils (not shown) that are wound around the rotor 21, and the armature 6 rotates. This rotation causes the impeller 16 to rotate, drawing the fuel inwards from the intake hole 22. As stated above, the fuel taken inwards is pressurized in the pump section 1, and is delivered to the inner space 2a of the motor section 2. The fuel passage within the motor section 2 will be described below.

Spaces 27 formed by the grooves 5b and the outer circumference face of the rotor 21 are utilized as fuel passages 27. When the highly pressurized fuel delivered from the pump section 1 to the inner space 2a of the motor section 2 is delivered towards the discharge port 28, these spaces 27 function as the fuel passages therefor.

If, as shown in FIG. 3, the fuel passages 27 shown in FIG. 2 were not formed in the ring magnet 5, the fuel passage would be only a minute clearance c between the rotor 21 and the ring magnet 5, and an insufficient quantity of fuel would flow. If the quantity of fuel flowing is insufficient, the performance of the fuel pump decreases. In addition, the heat generated by the coils of the rotor 21 cannot be cooled. If, to enable the flow of a sufficient quantity of fuel, the clearance c between the rotor 21 and the ring magnet 5 is made larger, the flow of magnetic flux through the rotor 21 decreases, and it is difficult to obtain a large motor torque.

In the present embodiment, the magnet 5 is ring shaped and encloses the entire circumference of the rotor 21, and the magnet 5 and the rotor 21 are located in extremely close proximity. By this means, a greater magnetic flux passes through the rotor 21. Furthermore, the fuel passages 27 are formed at locations removed from the magnetic path along which a substantial portion of the magnetic flux flows between the rotor 21, the magnet 5, and the yoke 4. The fuel passages 27 are formed at the boundaries between the poles of the magnet 5, and are therefore removed from the magnetic path along which a substantial portion of the magnetic flux flows. The present embodiment allows a large motor torque to be maintained, and simultaneously allows a fuel passage to be maintained that has sufficient cross-sectional area.

In the present embodiment, the ring magnet 5 is provided with four poles in the circumferential face, however, the number of the poles may not be limited to four. For instance, six poles may be provided, and in this case, six groves 5b may be provided.

(Second Embodiment)

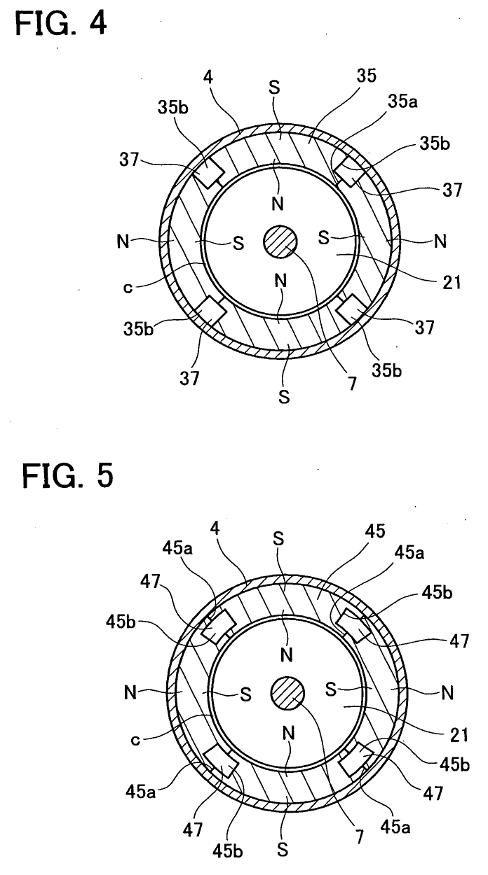

A second embodiment for practicing the present invention will be described. The present embodiment has approximately the same configuration as that of the first embodiment, and differs therefrom only in the shape of the magnet of the motor section. Consequently, only the portion differing from the first embodiment will be described here using FIG. 4, which corresponds to the cross-sectional view along the line II-II of FIG. 1. Components identical with those of the first embodiment have the same reference numbers assigned thereto.

As shown in FIG. 4, grooves 35b that extend in the axial direction are formed at locations where boundary lines 35a between poles of a magnet 35 are exposed at the outer circumference face. Spaces formed by the grooves 35b and the inner circumference face of the housing 4 are utilized as fuel passages 37. When the highly pressurized fuel delivered from the pump section 1 to the inner space 2a of the motor section 2 is delivered towards the discharge port 28, these fuel passages 37 function as the fuel passages therefor. The ring magnet 35 is physically integral even at the boundary line 35a between the poles of the magnet 35. This ring magnet 35 is not assembled from a plurality of magnet pieces to form a ring shape, but is instead formed from a material that was originally ring shaped.

In the present embodiment, the distance between the magnet 35 and the yoke 4 is greater at the locations where the fuel passages 37 are present. However, the boundaries 35a between the poles of the magnet 35 are distant from the magnetic path along which a substantial portion of the magnetic flux flows between the rotor 21, the magnet 35, and the yoke 4. The fuel passages 37 are therefore formed in locations removed from the magnetic path along which a substantial portion of the magnetic flux flows. Moreover, the magnet 35 is contiguous with inner sides of the fuel passages 37, and consequently the magnitude of the magnetic flux along the rotor 21, the magnet 35, and the yoke 4 is hardly affected by the presence or absence of the fuel passages 37. The presence of the fuel passages 37 hardly weakens the magnetic flux passing through the rotor 21. In the present embodiment, the rotor 21 and the magnet 35 face one another, separated by a small clearance, along their entire circumference. This increases the magnetic flux passing through the rotor 21. The present embodiment allows a large motor torque to be maintained, and simultaneously allows a fuel passage to be maintained that has sufficient cross-sectional area.

The inner circumference face of the ring magnet 35 is circular, and easily maintains a high degree of accuracy of shape. Even if there is very little difference between the outer diameter of the rotor 21 (which has a circular outer circumference face), and the inner diameter of the ring magnet 35 (which has a circular inner circumference face), it is possible to control the two such that they do not make contact. The rotor 21 and the magnet 35 face one another, separated by a small clearance, along their entire circumference, and the magnetic flux passing through the rotor 21 is increased.

(Third Embodiment)

A third embodiment for practicing the present invention will be described. The present embodiment has approximately the same configuration as that of the first embodiment and the second embodiment, and differs therefrom only in the shape of the magnet of the motor section. Consequently, only the portion differing from the first embodiment will be described here using FIG. 5, which corresponds to the cross-sectional view along the line II-II of FIG. 1. Components identical with those of the first embodiment have the same reference numbers assigned thereto.

As shown in FIG. 5, holes 45b that extend in the axial direction are formed within the interior of a magnet 45 at locations where boundary lines 45a between poles of the magnet 45 are located. The holes 45b are utilized as fuel passages 47. When the highly pressurized fuel delivered from the pump section 1 to the inner space 2a of the motor section 2 is delivered towards the discharge port 28, these fuel passages 47 function as the fuel passages therefor. The magnet 45 is physically integral even at the boundary lines 45a between the poles of the magnet 45. This magnet is not assembled from a plurality of magnet pieces to form a ring shape, but is instead formed from material that was originally ring shaped.

In the present embodiment, the cross-sectional area of the magnet 45 along the diameter becomes smaller at the boundaries 45a between the poles of the magnet 45. However, the boundaries 45a between the poles of the magnet 45 are in locations removed from the magnetic path along which a substantial portion of the magnetic flux flows between the rotor 21, the magnet 45, and the yoke 4. The fuel passages 47 are formed in locations distant from the magnetic path along which a substantial portion of the magnetic flux flows. Moreover, the magnet 45 is contiguous with inner and outer sides of the fuel passages 47, and consequently the magnitude of the magnetic flux circulating along the rotor 21, the magnet 45, and the yoke 4 is hardly affected by the presence or absence of the fuel passages 47. The presence of the fuel passages 47 hardly weakens the magnetic flux passing through the rotor 21. In the present embodiment, the rotor 21 and the magnet 45 face one another, separated by a small clearance, along their entire circumference. This increases the magnetic flux passing through the rotor 21. It is possible to maintain a large motor torque as well as the flow of a sufficient quantity of fuel.

The inner circumference face of the ring magnet 45 is circular, and easily maintains a high degree of accuracy of shape. Even if there is very little difference between the outer diameter of the rotor 21 (which has a circular outer circumference face), and the inner diameter of the ring magnet 45 (which has a circular inner circumference face), it is possible to control the two such that they do not make contact. The rotor 21 and the magnet 45 face one another, separated by a small clearance, along their entire circumference. The magnetic flux passing through the rotor 21 is thus increased. The outer circumference face of the ring magnet 45 is also circular, and easily maintains a high degree of accuracy of shape. The housing 4 (which has a circular inner circumference face) can easily be fitted completely with the ring magnet 45 (which has a circular outer circumference face). This also increases the magnetic flux passing through the rotor 21.

(Fourth Embodiment)

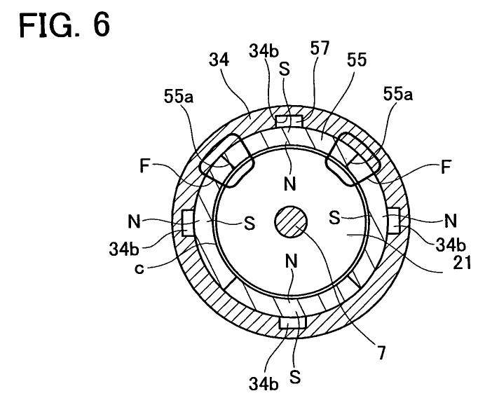

A fourth embodiment for practicing the present invention will be described. The present embodiment has approximately the same configuration as that of the first embodiment, and differs therefrom only in the shape of the housing and the shape of the magnet of the motor section. Consequently, only the portions differing from the first embodiment will be described here using FIG. 6, which corresponds to the cross-sectional view along the line II-II of FIG. 1. Components identical with those of the first embodiment have the same reference numbers assigned thereto.

As shown in FIG. 6, grooves 34b that extend in the axial direction are formed at the inner circumference face of a yoke (housing) 34 at locations corresponding to the approximate center of poles at the outer circumference face of a ring magnet 55. The grooves 34b are formed in four locations in the inner circumference face of the yoke 34.

A substantial portion of the magnetic flux F flows along a magnetic path passing through the S pole at the inner circumference face side of the magnet 55, the rotor 21, the N pole at the inner circumference face side of the magnet 55, the S pole at the outer circumference face side of the magnet 55, the yoke 34, and the N pole at the outer circumference face side of the magnet 55. The locations of the grooves 34b, this corresponding to the approximate center of the poles of the magnet 55, is removed from the magnetic path along which a substantial portion of the magnetic flux F flows. As a result, the presence of grooves 34b hardly weakens the magnetic flux passing through the rotor 21. In the present embodiment, the fuel passages 57 are formed in locations removed from the magnetic path along which a substantial portion of the magnetic flux flows between the rotor 21, the magnet 55, and the yoke 34. Consequently, these grooves 34b or fuel passages 57 hardly exert a weakening influence on the magnetic flux passing through the rotor 21. The present embodiment allows a large motor torque to be maintained.

Spaces formed by the grooves 34b and an outer wall face of the magnet 55 are utilized as fuel passages 57. When the highly pressurized fuel delivered from the pump section 1 to the inner space 2a of the motor section 2 is delivered towards the discharge port 28, these spaces 57 function as the fuel passages therefor.

In the present embodiment, the magnet 55 is ring shaped and encloses the entire circumference of the rotor 21. The ring magnet 55 and the rotor 21 can be located close to one another, and the flux passing through the rotor 21 can thus be increased. The clearance between the rotor 21 and the ring magnet 55 can be controlled so that its width is constant, and extremely small, along the entire circumference. The present embodiment allows both a large motor torque and the flow of a sufficient quantity of fuel.

(Fifth Embodiment)

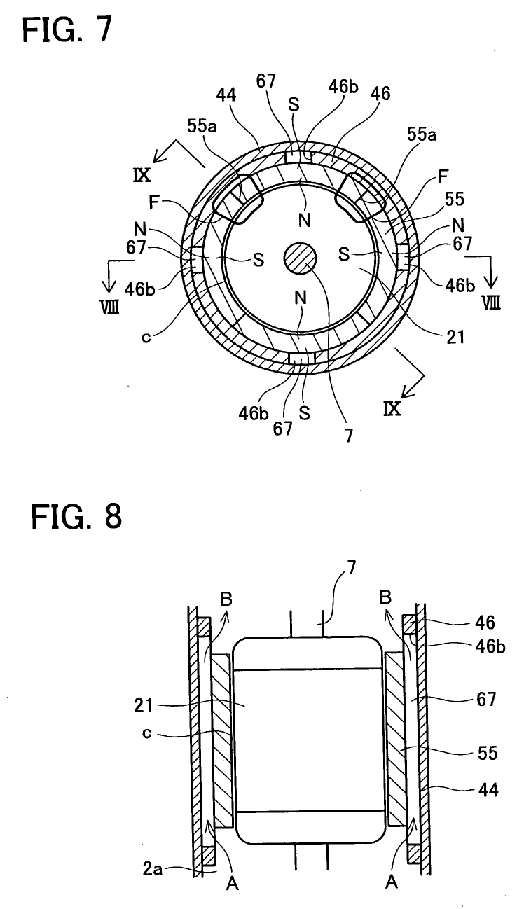

A fifth embodiment for practicing the present invention will be described. The present embodiment has approximately the same configuration as that of the fourth embodiment, and differs therefrom only in the configuration of the housing, etc. Consequently, only the portion differing from the fourth embodiment will be described using FIG. 7, which corresponds to the cross-sectional view along the line II-II of FIG. 1, and using FIG. 8, which is a cross-sectional view along the line VIII-VIII of FIG. 7. Components identical with those of the fourth embodiment have the same reference numbers assigned thereto.

As shown in FIG. 7, in a fuel pump of the present embodiment, a yoke 46 is provided between a housing 44 and the magnet 55. Like the magnet 55, the yoke 46 is cylindrical. The outer circumference face of the yoke 46 fits tightly with the inner circumference face of the housing 44, and the inner circumference face of the yoke 46 fits tightly with the outer circumference face of the magnet 55. As shown in FIG. 8, the length of the yoke 46 in the axial direction is longer than the length of the magnet 55 in the axial direction.

As shown in FIG. 7 and FIG. 8, holes 46b that extend in the axial direction are formed within the yoke 46 at locations corresponding to the approximate center of each pole of the magnet 55. The holes 46b pass through the inner circumference face and the outer circumference face of the yoke 46. The holes 46b are formed in four locations spaced equally along the circumference direction of the yoke 46. The length of the holes 46b in the axial direction is longer than the length of the magnet 55 in the axial direction. As shown in FIG. 7, the holes 46b are facing the approximate center of each of the poles at the outer circumference face of the magnet 55.

A substantial portion of the magnetic flux F flows along a magnetic path passing through the S pole at the inner circumference face side of the magnet 55, the rotor 21, the N pole at the inner circumference face side of the magnet 55, the S pole at the outer circumference face side of the magnet 55, the yoke 46, and the N pole at the outer circumference face side of the magnet 55. The location of the holes 46b, this corresponding to the approximate center of the poles of the magnet 55, is distant from the magnetic path along which a substantial portion of the magnetic flux F flows. As a result, the presence of the holes 46b hardly weakens the magnetic flux passing through the rotor 21. In the present embodiment, the holes 46b for forming fuel passages 67 are formed in locations removed from the magnetic path along which a substantial portion of the magnetic flux flows between the rotor 21, the magnet 55, and the yoke 46. Consequently, these fuel passages 67 hardly exert a weakening influence on the magnetic flux passing through the rotor 21. The present embodiment allows a large motor torque to be maintained.

Spaces 67 formed by the holes 46b, the inner circumference face of the housing 44, and an outer wall face of the magnet 55, are utilized as fuel passages 67. When the highly pressurized fuel is delivered from the pump section 1 to the inner space 2a of the motor section 2, this fuel is delivered to the fuel passages 67 as shown by the arrows A in FIG. 8, passes through these fuel passages 67, and is delivered towards the discharge port 28, as shown by the arrows B.

In the present embodiment, the magnet 55 is ring shaped and encloses the entire circumference of the rotor 21. Further, by locating the ring magnet 55 and the rotor 21 extremely close to one another, a high concentration of flux can be maintained. Moreover, since the holes 46b, which form the fuel passages 67, are formed in the yoke 46 that fits tightly between the housing 44 and the magnet 55, the flow of a sufficient quantity of fuel can be maintained. The present embodiment allows a large motor torque as well as the flow of a sufficient quantity of fuel.

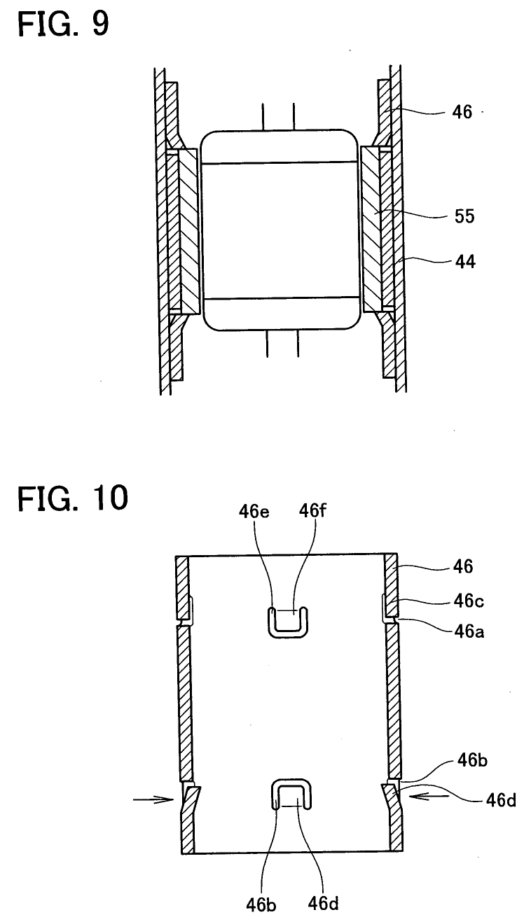

Next, the process for assembling the magnet 55, the yoke 46, and the housing 44 will be described using FIGS. 9 to 12. FIG. 9 is a cross-sectional view along the line IX-IX of FIG. 7. FIGS. 10 to 12 are figures for explaining the assembly process as in FIG. 9. Moreover, the terms ‘up’ and ‘down’ used below refer to ‘up’ and ‘down’ in the figures.

In the fuel pump of the present embodiment, the magnet 55, the yoke 46, and the housing 44 are all ring shaped and must be fitted tightly together. To do so, the magnet 55 is first press fitted into the yoke 46, and next the yoke 46, which has the magnet 55 assembled therewith, is press fitted into the housing 44.

FIG. 10 is a vertical cross-sectional view of the yoke 46. As shown in FIG. 10, U-shaped holes 46a, and holes 46b that correspond thereto and are symmetrical in an up-down direction, are formed in a circumference face of the yoke 46 and are separated by predetermined distances in the axial direction. These sets of holes are formed at four equally spaced locations along the circumference direction. Projections 46c are formed at an inner side portion of each of the holes 46a provided at an upper side, and projections 46d are formed at an inner side portion of each of the holes 46b provided at a lower side. The distance between lower ends of the projections 46c and upper ends of the projections 46d is approximately identical with the length, in the axial direction, of the magnet 55. Further, only one of the holes 46a is formed slightly lower than the remaining three holes 46a. To distinguish this from the others, this will be termed a hole 46e, and the projection at its inner side portion will be termed a projection 46f.

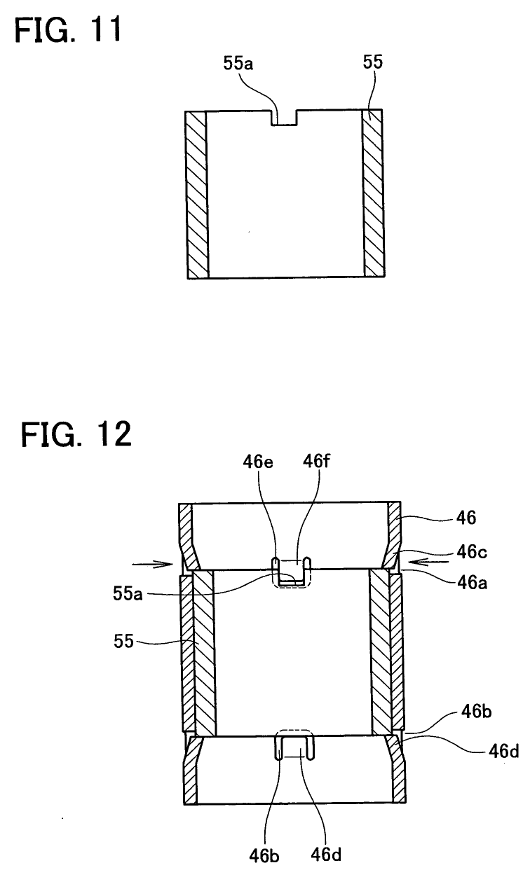

FIG. 11 is a vertical cross-sectional view of the magnet 55. A lower end of the magnet 55 is flat, and a recess 55a is formed at one location in an upper end of the magnet 55.

As shown by the arrow in FIG. 10, a lower end of each of the projections 46d functions as an axis and is rotated slightly towards an inner side of the yoke 46. The magnet 55, shown in FIG. 11, is press fitted from above into the interior of the yoke 46 that is in this state. At this juncture, the projection 46f that is slightly lower than the remaining projections 46c, and the recess 55a of the magnet 55, are press fitted so as to fit together, and the state shown in FIG. 12 is reached. The lower end of the magnet 55 is supported by upper ends of the projections 46d that protrude at the inner side of the yoke 46, and the magnet 55 is thus prevented from being removed downwards.

As shown by the arrow in FIG. 12, an upper end of each of the projections 46c functions as an axis and is rotated slightly towards the inner side of the yoke 46. By this means, the upper end of the magnet 55 is supported by lower ends of the projections 46c that protrude at the inner side of the yoke 46, and the magnet 55 is thus prevented from being removed upwards. At the same time, the recess 55a of the magnet 55 is supported by a lower end of the projection 46f. By this means, the magnet 55 is prevented from rotating relative to the yoke 46. The fitting of the projection 46f and the recess 55a prevents relative rotation, and relative movement in the axial direction, of the magnet 55.

The magnet 55 and the yoke 46 that have been assembled in this manner are press fitted, as shown in FIG. 9, into the housing 44.

Since the magnet 55 must be tightly fitted within the yoke 46, it is press fitted into the yoke 46. However, the magnet 55 may not withstand the pressure at this juncture, and may be damaged.

In the present embodiment, the projections 46c and 46d are provided in the yoke 46, and the ends of the magnet 55 fit with and are supported by these projections 46c and 46d. By this means, the magnet 55 is prevented from moving in the axial direction.

Further, in the present embodiment, the recess 55a is formed in the end of the magnet 55, and the projection 46f is formed in the yoke 46. The projection 46f engages with the recess 55a of the magnet 55, thus preventing the magnet 55 from rotating.

Due to this, fitting the magnet 55 together with the yoke 46 prevents the magnet 55 from moving in the axial direction or the circumference direction. Consequently, the press fitting force is suppressed when the magnet is press fitted into the yoke. Damage to the magnet 55 during press fitting can thus be prevented.

Further, the yoke 46 and the housing 44 are strong enough to be press fitted with enough strength to prevent movement in the axial direction and the circumference direction.

(Sixth Embodiment)

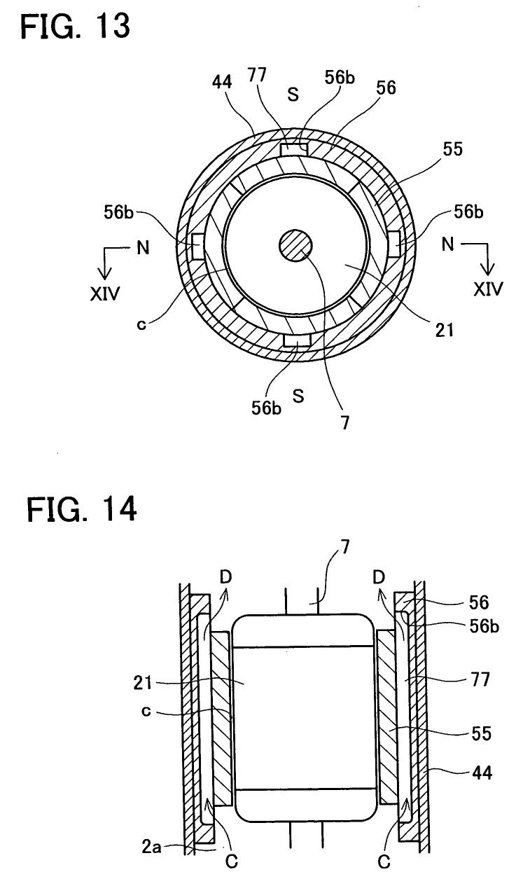

A sixth embodiment for practicing the present invention will be described. The present embodiment has approximately the same configuration as that of the fifth embodiment, and differs therefrom only in the configuration of the yoke. Consequently, only the portion differing from the fifth embodiment will be described using FIG. 13, which corresponds to the cross-sectional view along the line II-II of FIG. 1, and using FIG. 14, which is a cross-sectional view along the line XIV-XIV of FIG. 13. Components identical with those of the fifth embodiment have the same reference numbers assigned thereto.

As shown in FIG. 13, in a fuel pump of the present embodiment also, a yoke 56 is provided between the housing 44 and the magnet 55. Like the magnet 55, the yoke 56 is cylindrical. The outer circumference face of the yoke 56 fits tightly with the inner circumference face of the housing 44, and the inner circumference face of the yoke 56 fits tightly with the outer circumference face of the magnet 55. As shown in FIG. 14, the length of the yoke 56 in the axial direction is longer than the length of the magnet 55 in the axial direction.

As shown in FIG. 13 and FIG. 14, grooves 56b that extend in the axial direction are formed in four locations in the inner circumference face of the yoke 56. The length of the grooves 56b in the axial direction is longer than the length of the magnet 55 in the axial direction. As shown in FIG. 13, the grooves 56b are facing the approximate center of each of the poles at the outer circumference face of the magnet 55. A substantial portion of the magnetic flux F flows along a magnetic path passing through the S pole at the inner circumference face side of the magnet 55, the rotor 21, the N pole at the inner circumference face side of the magnet 55, the S pole at the outer circumference face side of the magnet 55, the yoke 56, and the N pole at the outer circumference face side of the magnet 55. The location of the grooves 56b, this corresponding to the approximate center of the poles of the magnet 55, is distant from the magnetic path along which a substantial portion of the magnetic flux F flows. As a result, the presence of the grooves 56b hardly weakens the magnetic flux passing through the rotor 21. In the present embodiment, the grooves 56b are formed in locations removed from the magnetic path along which a substantial portion of the magnetic flux flows between the rotor 21, the magnet 55, and the yoke 56. Consequently, the grooves 56b hardly exert a weakening influence on the magnetic flux passing through the rotor 21. The present embodiment allows a large motor torque to be maintained.

Spaces 77 formed by the grooves 56b and the outer wall face of the magnet 55 are utilized as fuel passages 77. When the highly pressurized fuel is delivered from the pump section 1 to the inner space 2a of the motor section 2, this fuel is delivered to the fuel passages 77 as shown by the arrows C in FIG. 14, passes through these fuel passages 77, and is delivered towards the discharge port 28, as shown by the arrows D.

(Seventh Embodiment)

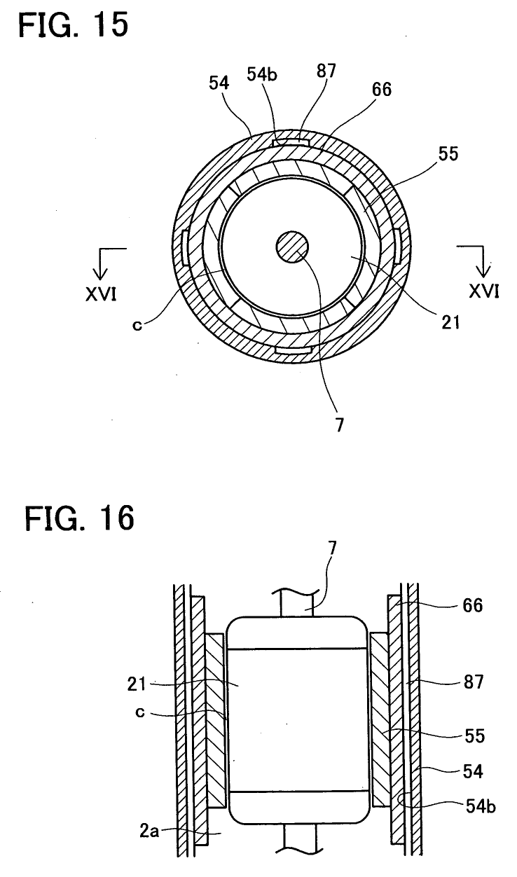

A seventh embodiment for practicing the present invention will be described. The present embodiment has approximately the same configuration as that of the sixth embodiment, and differs therefrom only in the configuration of the housing and the yoke. Consequently, only the portion differing from the sixth embodiment will be described using FIG. 15, which corresponds to the cross-sectional view along the line II-II of FIG. 1, and using FIG. 16, which is a cross-sectional view along the line XVI-XVI of FIG. 15. Components identical with those of the sixth embodiment have the same reference numbers assigned thereto.

As shown in FIG. 15, in a fuel pump of the present embodiment also, a yoke 66 is provided between a housing 54 and the magnet 55. Like the magnet 55, the yoke 66 is cylindrical. The outer circumference face of the yoke 66 fits tightly with the inner circumference face of the housing 54, and the inner circumference face of the yoke 66 fits tightly with the outer circumference face of the magnet 55.

As shown in FIG. 15 and FIG. 16, grooves 54b that extend in the axial direction are formed in four locations in the inner circumference face of the housing 54. The length of the grooves 54b in the axial direction is longer than the length of the magnet 55 in the axial direction. The grooves 54b can be formed in any position. A substantial portion of the magnetic flux F flows along a magnetic path passing through the S pole at the inner circumference face side of the magnet 55, the rotor 21, the N pole at the inner circumference face side of the magnet 55, the S pole at the outer circumference face side of the magnet 55, the yoke 66, and the N pole at the outer circumference face side of the magnet 55. The magnetic flux does not flow through the housing 54. The grooves 54b are removed from the magnetic path. As a result, the presence of the grooves 54b hardly weakens the magnetic flux passing through the rotor 21. In the present embodiment, the grooves 54b are formed in locations removed from the magnetic path and consequently hardly exert a weakening influence on the magnetic flux passing through the rotor 21. The present embodiment allows a large motor torque to be maintained.

Spaces formed by the grooves 54b and an outer wall face of the yoke 66 are utilized as fuel passages 87. When the highly pressurized fuel is delivered from the pump section 1 to the inner space 2a of the motor section 2, this fuel is delivered to the fuel passages 87, passes through these fuel passages 87, and is delivered towards the discharge port 28.

The first to fourth embodiments have a configuration without an independent yoke. When the housing is made from metal, the inner circumference face of the housing functions as the yoke, and consequently there is no need to provide a yoke specially.

The fifth to seventh embodiments have a configuration which has a yoke. This renders it easier to mold the inner circumference face of the housing. Further, the housing need not be made from metal, and consequently can be made from other materials, such as resin. Forming the housing from resin renders it even easier to mold, and costs can be lowered in materials, processing, etc.

(Eighth Embodiment)

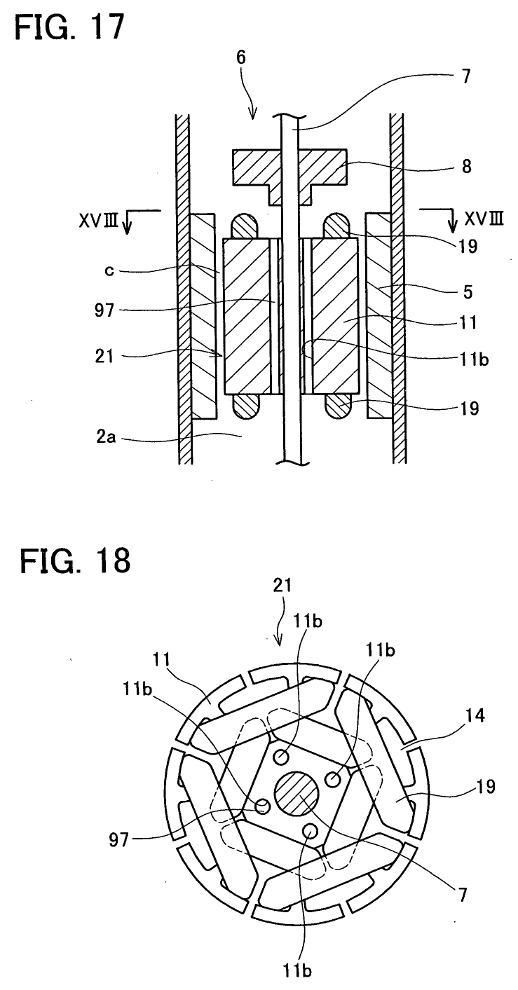

An eighth embodiment for realizing the present invention will be described using FIGS. 17 and 18. In the present embodiment, the components that comprise the fuel passage differ. Consequently, only the portion differing from the above embodiments will be described. Identical components have the same reference numbers as in the first embodiment assigned thereto. FIG. 17 is a vertical cross-sectional view of essential parts of the fuel pump of the present embodiment. FIG. 18 is a cross-sectional view along the line XVIII-XVIII of the rotor of FIG. 17.

As shown in FIG. 17, the armature 6 comprises a core 11 consisting of laminated magnetic plates, coils 19 that are wound around slots 14 of the core 11, the commutator 8 that supplies current to the coils 19, and the shaft 7 that supports the core 11 and the commutator 8.

As shown in FIGS. 17 and 18, holes 11b are formed in the vicinity of the center of the core 11. The holes 11b extend in the axial direction and pass through the core 11 in the axial direction. The holes 11b are utilized as fuel passages 97. The highly pressurized fuel that is delivered to the inner space 2a is delivered to the fuel passages 97, passes through these fuel passages 97, and is delivered towards the discharge port 28.

In the present embodiment, the holes 11b in the vicinity of the center of the core 11 within the rotor 21 form the fuel passages 97. It is thus possible to maintain the flow of a sufficient quantity of fuel without enlarging the clearance c between the rotor 21 and the magnet 5. The present embodiment allows both a large motor torque and the flow of a sufficient quantity of fuel.

The vicinity of the center of the core 11 is removed from the through path of the magnetic flux passing through the rotor 21. Even though the holes 11b have been formed in the vicinity of the center of the core 11, this does not reduce the magnetic flux passing through the rotor 21.

(Ninth Embodiment)

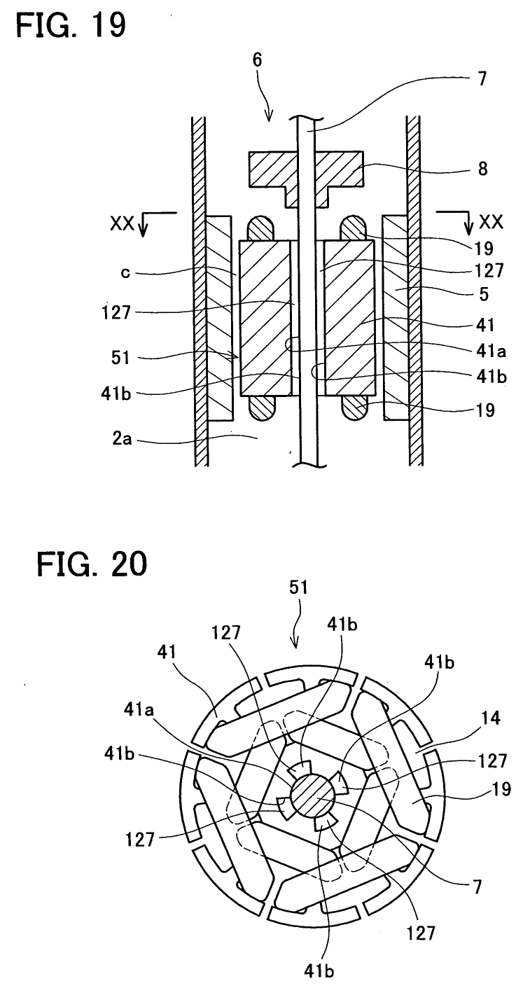

A ninth embodiment for practicing the present invention will be described using FIGS. 19 and 20. The present embodiment has approximately the same configuration as that of the eighth embodiment, and differs therefrom in the components that comprise the fuel passage. Consequently, only the portion differing from the eighth embodiment will be described. Identical components have the same reference numbers assigned thereto. FIG. 19 is a vertical cross-sectional view of essential parts of the fuel pump of the present embodiment. FIG. 20 is a cross-sectional view along the line XX-XX of the rotor of FIG. 19.

As shown in FIGS. 19 and 20, holes 41b that extend in a radial direction are formed at a center hole 41a of a core 41. The shaft 7 is inserted into the center hole 41a. The grooves 41b are utilized as fuel passages 127. The highly pressurized fuel that is delivered to the inner space 2a is delivered to the fuel passages 127, passes through these fuel passages 127, and is delivered towards the discharge port 28.

The vicinity of the center of the core 41 is distant from the through path of the magnetic flux passing through the core 41. Even though the grooves 41b are formed in the vicinity of the center of the core 41, the torque that causes the armature 6 to rotate does not decrease.

The fuel pumps in the eighth embodiment and the ninth embodiment have a configuration without a yoke. However, the same effects can be obtained using fuel pumps configured to have a yoke, like those in the fifth to seventh embodiments.

The process for assembling the magnet has been described using FIGS. 9 to 12. However, the process for assembling the magnet is not restricted to this example, but can also be performed as shown in the tenth to twelfth embodiments below.

(Tenth Embodiment)

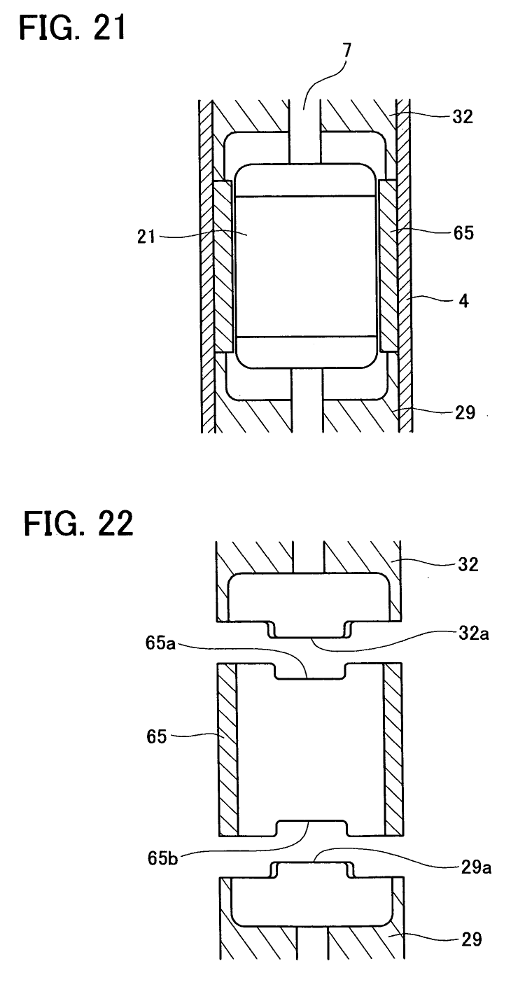

A tenth embodiment for practicing the present invention will be described using FIGS. 21 and 22. The process for assembling the magnet 65 shown in the present embodiment can be applied to any of the fuel pumps from the first embodiment to the ninth embodiment. In the present embodiment, a case is described wherein the process for assembling the magnet 65 is applied to the fuel pump of the first embodiment. In this description, components identical with those of the first embodiment have the same reference numbers assigned thereto. Furthermore, the terms ‘up’ and ‘down’ used below refer to ‘up’ and ‘down’ in the figures.

FIG. 21 is a view schematically showing a vertical cross-section of a motor section of a fuel pump. As shown in FIG. 21, a lower end of a motor cover 32 makes contact with an upper end of a magnet 65, and an upper end of a pump cover 29 makes contact with a lower end of the magnet 65. This will be described in detail using FIG. 22. FIG. 22 is a figure for explaining the process for assembling the magnet 65, and is a vertical cross-sectional view of the motor cover 32, the magnet 65, and the pump cover 29. As shown in FIG. 22, a flat rectangular recess 65a is formed in one location in the upper end of the magnet 65, and a flat rectangular recess 65b is formed in one location in the lower end of the magnet 65. Further, a flat rectangular projection 32a is formed in one location in the lower end of the motor cover 32, and a flat rectangular projection 29a is formed in one location in the upper end of the pump cover 29. The projection 32a of the motor cover 32 fits with the recess 65a of the magnet 65. The projection 29a of the pump cover 29 fits with the recess 65b of the magnet 65.

When the above members are to be assembled, the magnet 65 is first inserted into the housing 4. Then the motor cover 32 is inserted from an upper end of the housing 4, and the pump cover 29 is inserted from a lower end of the housing 4. The motor cover 32 and the pump cover 29 thus grip the magnet 65 from above and below. As a result, the magnet 65 is prevented from moving in an up-down direction (the axial direction).

Furthermore, when the motor cover 32 and the pump cover 29 are to be inserted into the housing 4, the projection 32a of the motor cover 32 is fitted with the recess 65a of the magnet 65, and the projection 29a of the pump cover 29 is fitted with the recess 65b of the magnet 65. By this means, the magnet 65 is prevented from rotating (moving in the circumference direction).

The rotation (movement in the circumference direction) of the magnet 65 can also be prevented by forming a projection on only one of the motor cover 32 and the pump cover 29, and fitting this projection with a recess of the magnet 65.

The movement of the magnet 65 in the axial direction and the circumference direction can thus be prevented by fitting the magnet 65 together with at least one of the motor cover 32 and the pump cover 29. Consequently, the degree of press fitting can be suppressed, and damage to the magnet 65 during press fitting can be prevented.

(Eleventh Embodiment)

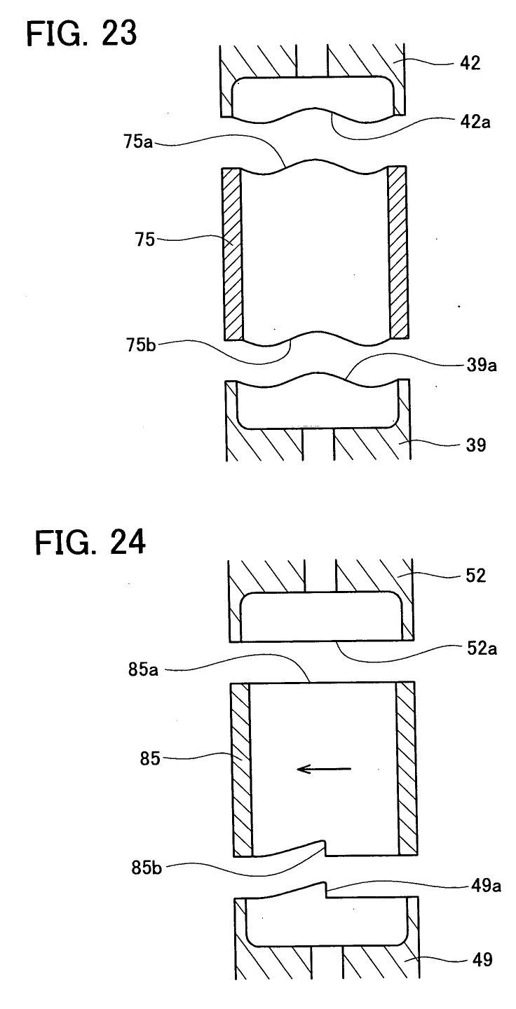

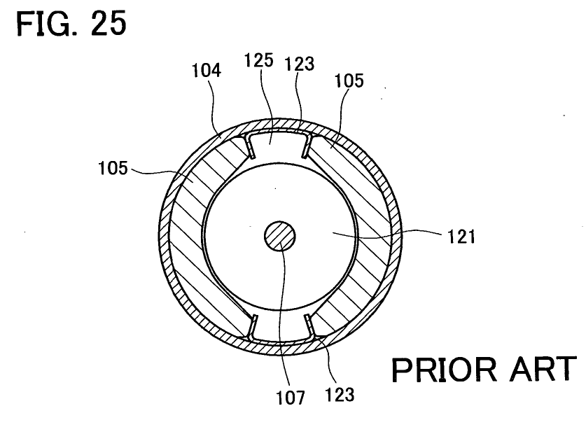

An eleventh embodiment for practicing the present invention will be described using FIG. 23. The process for assembling the magnet shown in the present embodiment can be applied to any of the fuel pumps from the first embodiment to the ninth embodiment. In the present embodiment, as well, a case is described wherein the process for assembling the magnet is applied to the fuel pump of the first embodiment. In this description, components identical with those of the first embodiment have the same reference numbers assigned thereto. Furthermore, the terms ‘up’ and ‘down’ used below refer to ‘up’ and ‘down’ in the figures.

FIG. 23 is a figure for explaining the process for assembling a magnet 75, and is a vertical cross-sectional view of a motor cover 42, the magnet 75, and a pump cover 39. As shown in FIG. 23, an upper end 75a and a lower end 75b of the magnet 75 are both formed in a wave shape. Further, a lower end 42a of motor cover 42, and an upper end 39a of the pump cover 39 are also formed in a wave shape. The wave shape of the lower end 42a of the motor cover 42 corresponds with the wave shape of the upper end 75a of the magnet 75. The wave shape of the upper end 39a of the pump cover 39 corresponds with the wave shape of the lower end 75b of the magnet 75. That is, the lower end 42a of the motor cover 42 and the upper end 75a of the magnet 75 fit together. Further, the upper end 39a of the pump cover 39 and the lower end 75b of the magnet 75 fit together.

As with the tenth embodiment, when the above members are to be assembled, the magnet 75 is first inserted into the housing 4. Then the motor cover 42 is inserted from the upper end of the housing 4, and the pump cover 39 is inserted from the lower end of the housing 4. The motor cover 42 and the pump cover 39 thus grip the magnet 75 from above and below. At this juncture, the projection 42a of the motor cover 42 is fitted with the recess 75a of the magnet 75, and the projection 39a of the pump cover 39 is fitted with the recess 75b of the magnet 75. By this means, the magnet 75 is prevented from moving in an up-down direction (moving in the axial direction), and from rotating (moving in the circumference direction).

The rotation (movement in the circumference direction) of the magnet 75 can also be prevented by forming only one end of the magnet 75 in a wave shape, and forming one end of either the motor cover 42 or the pump cover 39 in a wave shape. This wave-shaped end will then be fitted with the end of the magnet 75.

The movement of the magnet 75 in the axial direction and the circumference direction can thus be prevented by fitting the magnet 75 together with at least one of the motor cover 42 or the pump cover 39. Consequently, the degree of press fitting can be suppressed, and damage to the magnet 75 during press fitting can be prevented. Furthermore, even if the magnet 75 is a comparatively weak plastic magnet or the like, the wave shape of the ends of the magnet 75 means that it does not easily chip.

(Twelfth Embodiment)

A twelfth embodiment for practicing the present invention will be described using FIG. 24. The process for assembling the magnet shown in the present embodiment can be applied to any of the fuel pumps from the first embodiment to the ninth embodiment, as long as this is a fuel pump in which the motor has a constant direction of rotation. In the present embodiment, also, a case is described wherein the process for assembling the magnet is applied to the fuel pump of the first embodiment. In this description, components identical with those of the first embodiment have the same reference numbers assigned thereto. Furthermore, the terms ‘up’ and ‘down’ used below refer to ‘up’ and ‘down’ in the figures.

FIG. 24 is a figure for explaining the process for assembling a magnet 85, and is a vertical cross-sectional view of a motor cover 52, the magnet 85, and a pump cover 49. As shown in FIG. 24, an upper end 85a of the magnet 85 is flat. Further, a lower end 52a of the motor cover 52 is also flat. An approximately triangular projection is formed in an upper end 49a of the pump cover 49. One side of this projection extends in the axial direction. An approximately triangular recess is formed in a lower end 85b of the magnet 85. One side of this recess extends in the axial direction. The shape of the upper end 49a of the pump cover 49 corresponds with the shape of the lower end 85b of the magnet 85. That is, the upper end 49a of the pump cover 49 and the lower end 85b of the magnet 85 fit together.

As with the tenth embodiment, when the above members are to be assembled, the magnet 85 is first inserted into the housing 4. Then the motor cover 52 is inserted from the upper end of the housing 4, and the pump cover 49 is inserted from the lower end of the housing 4. The motor cover 52 and the pump cover 49 thus grip the magnet 85 from above and below. At this juncture, the projection of the upper end 49a of the pump cover 49 is fitted with the recess of the lower end 85b of the magnet 85. The shape of the projection of the pump cover 49 and the shape of the recess of the magnet 85 strongly prevent the magnet 85 from rotating in the direction of the arrow in the figure. By this means, the magnet 85 is prevented from moving in an up-down direction (moving in the axial direction), and from rotating in the constant direction (moving in the circumference direction).

If the direction of rotation of the rotor (21, see FIGS. 1, 21, etc.) is constant, the direction in which the magnet 85 will attempt to rotate, due to its receiving reactive force from the rotation of the rotor, is also constant. Consequently, as in the present embodiment, the shape of the recess of the magnet 85 and the shape of the projection of the pump cover 49 may be a shape capable of reliably preventing the magnet 85 from rotating in this constant direction.

In the present embodiment, the magnet 85 is prevented from rotating by fitting together the pump cover 49 and the magnet 85. However, the magnet 85 can also be prevented from rotating by fitting together the magnet 85 and the motor cover 52 in the same manner.

The movement of the magnet 85 in the axial direction and the circumference direction can thus be prevented by fitting the magnet 85 together with at least one of the pump cover 49 and the motor cover 52. Consequently, the degree of press fitting can be suppressed, and damage to the magnet 85 during press fitting can be prevented.

The explanation of assembly of the magnets, shown in embodiments 10 through 12, was applied to the fuel pump shown in the first embodiment, in which the housing also functions as the yoke. However, the explanation of assembly of the magnets, shown in embodiments 10 through 12, can also be applied to a fuel pump in which the housing and the yoke are separate members. In that case, when assembly occurs, the magnet is first inserted into the yoke, then this assembled magnet and yoke are press fitted into the housing. The motor cover or pump cover that fits together with the magnet is inserted into the housing which has the yoke and magnet assembled therein. The housing and the yoke fit together tightly, and consequently the same degree of effectiveness is obtained as in the fuel pump where the housing also functions as the yoke.

Specific examples of embodiments of the present invention have been described in detail above, but these merely illustrate some possibilities of the invention and do not restrict the claims thereof. The art set forth in the claims includes various transformations and modifications to the specific examples set forth above.

Furthermore, the technical elements disclosed in the present specification or figures may be utilized separately or in all types of conjunctions and are not limited to the conjunctions set forth in the claims at the time of submission of the application. Furthermore, the art disclosed in the present specification or figures may be utilized to simultaneously realize a plurality of aims or to realize one of these aims.

1. A fuel pump comprising a pump section and a motor section,
wherein the motor section comprises:
a columnar rotor having a shaft for rotating the pump section;
a ring magnet surrounding an outer circumference face of the rotor, there being a minute clearance between the rotor and the magnet; and
a cylindrical yoke surrounding and contacting an outer circumference face of the magnet, and
wherein a fuel passage is formed at a location removed from a magnetic path along which a substantial portion of magnetic flux flows between the rotor, the magnet, and the yoke.

2. The fuel pump as defined in claim 1,
wherein the fuel passage is formed at a boundary between poles of the ring magnet.

3. The fuel pump as defined in claim 2,
wherein the fuel passage is formed at an inner circumference face of the ring magnet.

4. The fuel pump as defined in claim 2,
wherein the fuel passage is formed at an outer circumference face of the ring magnet.

5. The fuel pump as defined in claim 2,
wherein the fuel passage is formed in the interior of the ring magnet.

6. The fuel pump as defined in claim 1,
wherein the fuel passage is formed in the interior of the rotor.

7. The fuel pump as defined in claim 1,
wherein the cylindrical yoke forms at least a portion of a housing of the fuel pump.

8. The fuel pump as defined in claim 1,
further comprising a cylindrical housing of the fuel pump surrounding and contacting an outer circumference face of the yoke.

9. The fuel pump as defined in claim 8,
wherein the fuel passage comprises a hole extending in an axial direction and passing through an inner circumference face and the outer circumference face of the yoke.

10. The fuel pump as defined in claim 9,
wherein the fuel passage is formed in a location facing a central part of one of the poles of the ring magnet.

11. The fuel pump as defined in claim 8,
wherein the fuel passage is formed in an inner circumference face of the yoke.

12. The fuel pump as defined in claim 11,
wherein the fuel passage is formed in a location facing a central part of one of the poles of the ring magnet.

13. The fuel pump as defined in claim 8,
wherein the fuel passage is formed in an inner circumference face of the housing.

14. The fuel pump as defined in claim 13,
wherein the fuel passage is formed in a location facing a central part of one of the poles of the ring magnet.

15. The fuel pump as defined in claim 1,
wherein the magnet and the yoke are mechanically coupled by at least one pair of a projection and a recess for receiving the projection so that relative movement between the magnet and the yoke along the axial direction, and relative rotation between the magnet and the yoke, are prevented.

16. The fuel pump as defined in claim 1,
further comprising a pump cover for separating the pump section and the motor section,
wherein the magnet is mechanically coupled to the pump cover by at least one pair of a projection and a recess for receiving the projection so that relative movement between the magnet and the pump cover along the axial direction, and relative rotation between the magnet and the pump cover, are prevented.

17. The fuel pump as defined in claim 1,
further comprising a motor cover for enclosing the motor section,
wherein the magnet is mechanically coupled to the motor cover by at least one pair of a projection and a recess for receiving the projection so that relative movement between the magnet and the motor cover along the axial direction, and relative rotation between the magnet and the motor cover, are prevented.
